(19) United States
(12) Patent Application Publication
(10) Pub. No.: US 2013/0087993 A1
(43) Pub. Date: Apr. 11, 2013

(54) Convertible Stroller

(71) Applicants: Gwendolyn M. Jacquet, Fontana, CA (US); Anjelle J. Jacquet, Fontana, CA (US)

(72) Inventors: Gwendolyn M. Jacquet, Fontana, CA (US); Anjelle J. Jacquet, Fontana, CA (US)

(21) Appl. No.: 13/267,592

(22) Filed: Oct. 6, 2011

(51) Int. Cl. B62B 3/00

(52) U.S. Cl. 280/647

(57) ABSTRACT

An apparatus comprises a frame and a plurality of wheels. A handle is pivotally joined to the frame. An adjustment mechanism is joined to the frame and the handle. The adjustment mechanism supports the handle at a plurality of angles. A seat assembly is configured to seat the occupant. The seat assembly is slidably joined to the handle. A locking mechanism secures the seat assembly in a first position with the seat assembly resting on the frame and the adjustment mechanism supporting the handle at an angle to recline the seat assembly in which the apparatus is configured as a stroller. The locking mechanism further secures the seat assembly in a second position with the seat assembly supported above the frame and the adjustment mechanism supporting the handle at an angle to position the seat assembly in an upright position in which the apparatus is configured as a highchair.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to childcare items. More particularly, the invention relates to a convertible stroller.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Parents frequently take their children with them when they go outside of the home. And since these trips can often take extended periods, one can expect that a feeding time may arise regardless of the location.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A through 1D illustrate an exemplary convertible stroller, in accordance with an embodiment of the present invention. FIG. 1A is a front perspective view. FIG. 1B is a rear perspective view. FIG. 1C is a side view with a seating area in a stroller position, and FIG. 1D is a side view with the seating area in a highchair position;

FIG. 2 is a side perspective view of exemplary adjustment means for a convertible stroller, in accordance with an embodiment of the present invention;

FIGS. 3A and 3B illustrate an exemplary locking latch, in accordance with an embodiment of the present invention. FIG. 3A is a cross sectional view of the latch in a locked position, and FIG. 3B is a cross sectional view of the latch in a retracted position; and

FIGS. 4A through 4C illustrate an exemplary convertible stroller, in accordance with an embodiment of the present invention. FIG. 4A is a side view of the stroller with a seating area in a highchair position. FIG. 4B is a side view of the stroller with the seating area in a stroller position, and FIG. 4C is a rear perspective view of the seating area.

Unless otherwise indicated illustrations in the figures are not necessarily drawn to scale.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

A practical embodiment of the present invention operates as both a stroller and a highchair and adjusts in such operation by allowing a seating area to be raised, lowered and adjusted in angle of position to accommodate each individual format of use. Many practical embodiments enable families with small children to be personally accommodated in a wide variety of environments including, without limitation, restaurants. Many restaurants provide highchairs; however, these highchairs are used by a countless number of customers and run a high risk of collecting dirt and germs.

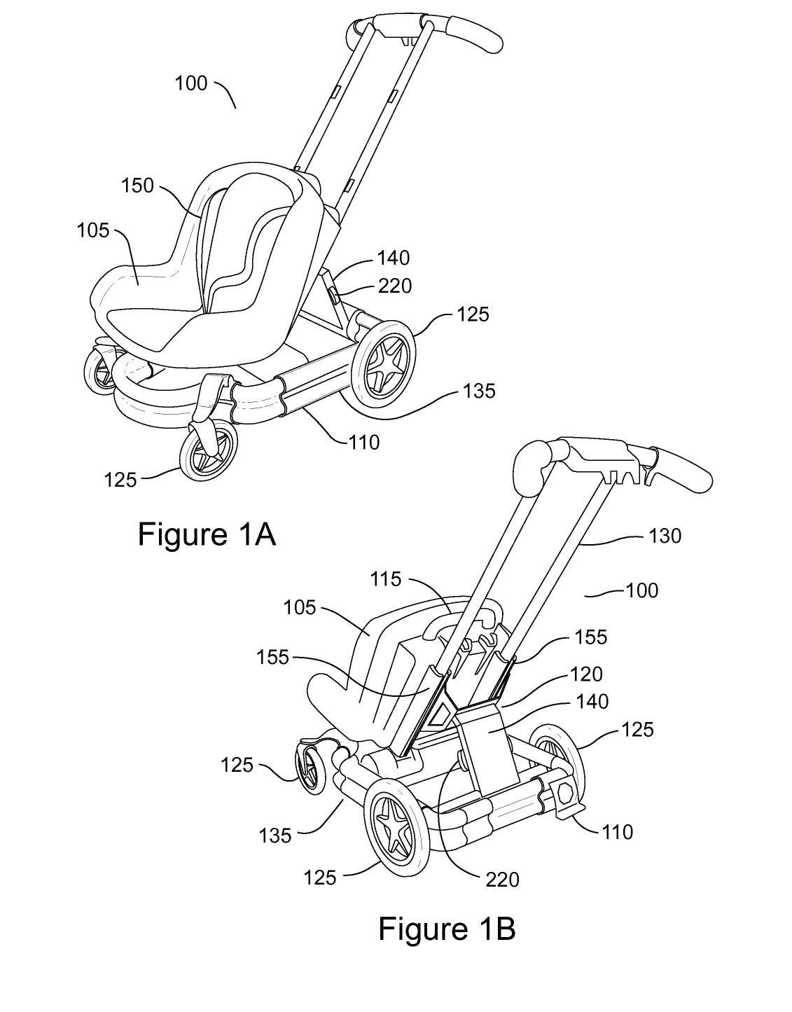

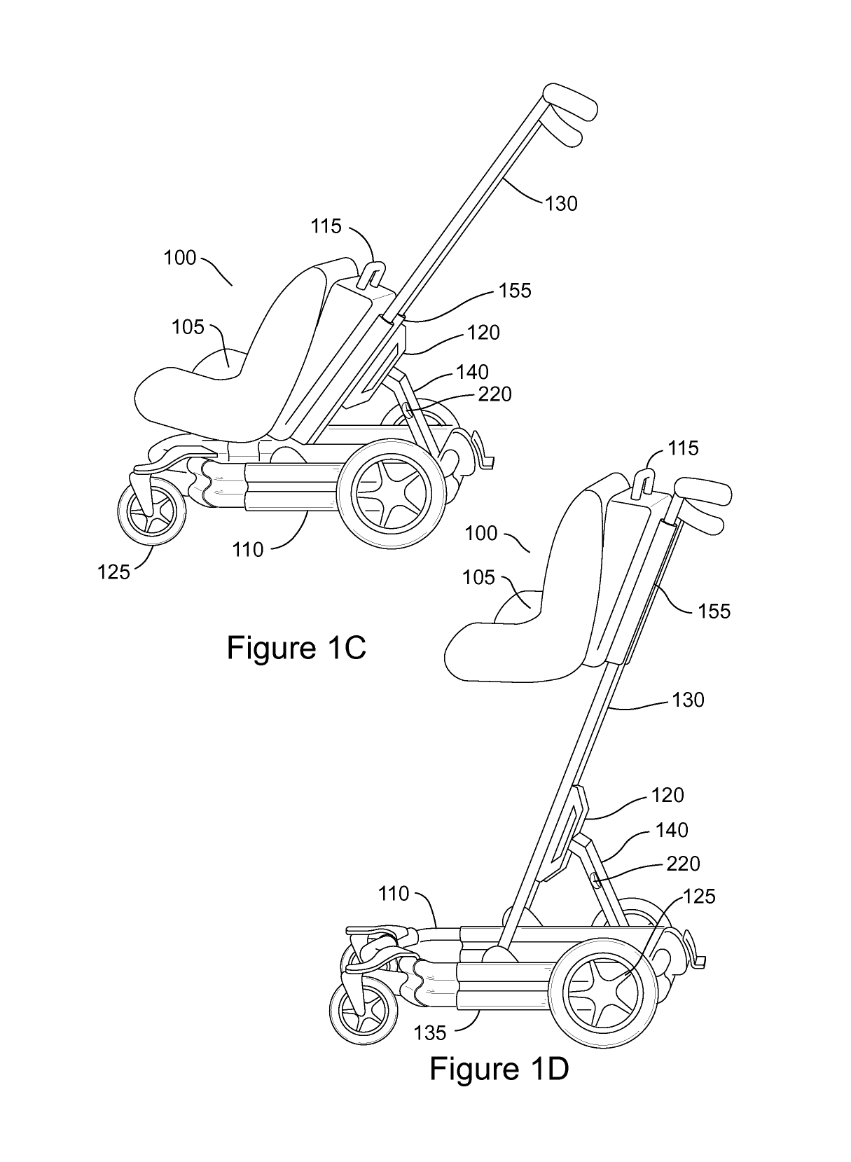

FIGS. 1A through 1D illustrate an exemplary convertible stroller 100, in accordance with an embodiment of the present invention. FIG. 1A is a front perspective view. FIG. 1B is a rear perspective view. FIG. 1C is a side view with a seating area 105 in a stroller position, and FIG. 1D is a side view with seating area 105 in a highchair position. In the present embodiment, convertible stroller 100 comprises seating area 105, a stroller frame 110 upon which seating area 105 rests, locking latches that secure seating area 105 upon stroller frame 110, a release lever 115 for the locking latches that enable seating area 105 to be raised or lowered, and a hinge 120 that adjusts the angle of seating area 105. Stroller frame 110 comprises four (4) wheels 125 for mobility and foot-controlled brakes that can lock wheels 125 in a set and unmovable position. It is contemplated that some alternate embodiments may be implemented with fewer or more wheels. For example, without limitation, one alternate embodiment may comprise three wheels in a triangular formation.

In the present embodiment, stroller frame 110 is an aluminum frame of the convertible stroller 100 that measures, when in the stroller position, approximately forty inches in height by forty inches in length by twenty inches in width (40″×40″×20″). In some alternate embodiments this frame may be made of various different materials such as, but not limited to, plastic and may be made in a variety of sizes. In some embodiments the base area of the stroller may be weighted to generally ensure its stability when in the highchair position. In the present embodiment, frame 110 rests upon four (4) wheels 125 at each corner of its lower horizontal plane. The front two (2) wheels 125 are free-rotating and have a diameter of approximately four inches (4″), and the rear wheels 125 each measure approximately six inches (6″) in diameter. All wheels 125 have treading of a rubber material; however, wheels in some alternate embodiments may not comprise such treading. In some alternate embodiments all four (4) of the wheels may swivel. Some alternate embodiments may comprise wheels of various different sizes in which the front and rear wheels may be the same size or different sizes. In the present embodiment securing brakes are fitted upon wheels 125 so that stroller 100 can be secured in a locked position to generally prevent its movement whenever desired, including, without limitation, when being used as a highchair. The wheel brakes may be applied to the rear two (2) wheels 125 or all four (4) wheels 125. In some alternate embodiments, the stroller may be made in variations that require the wheel brakes to be fully locked before the seating area can be raised or lowered.

In the present embodiment, handles 130 extend from frame 110 at pivot point mounts 135 that allow the angle of handles 130 to be adjusted. A sliding angle adjustment mechanism 140 fits upon the rear horizontal portion of frame 110. The opposite end of sliding angle adjustment mechanism 140 connects to rotating hinge 120 that attaches upon the rear of seating area 105. Pivot mounts 135 and sliding angle adjustment mechanism 140 enable handles 130 to be adjusted to various different angles to enable stroller 100 to be used in a wide variety of locations such as, but not limited to, at large or tall tables, at kitchen counters, as a stand-alone highchair, etc. The adjustable angle of handles 130 enables seating area 105 to be upright when in the highchair position and slightly reclined when in the stroller position, which may be more comfortable for a child seated in seating area 105. The adjustability of handles 130 also enables stroller 100 to be collapsible for storage and transport. In some alternate embodiments, the stroller may not be of a collapsible format, and in some alternate embodiments, the seating area may not be capable of achieving a reclining position while in the stroller position of operation. Other alternate embodiments may be implemented without adjustable handles.

In the present embodiment, seating area 105 measures approximately twenty inches in height by eight inches in depth by twelve inches in width (20″×8″×12″). The frame of seating area 105 is made of a high-density polyethylene (HDPE) and is fitted with padded cushioning that is lined with a waterproof nylon material. It is contemplated that the seating areas in some alternate embodiments may be made in various different sizes and may be made of a multiplicity of suitable materials. In the present embodiment, a safety harness 150 is included, without limitation, to secure the occupant within seating area 105. Harness 150 may be of five (5) or three (3) point format. Seating area 105 fits upon and attaches to extending handles 130 of frame 110 by braces 155 with semi-circular channels that are of matching diameter to extending handles 130.

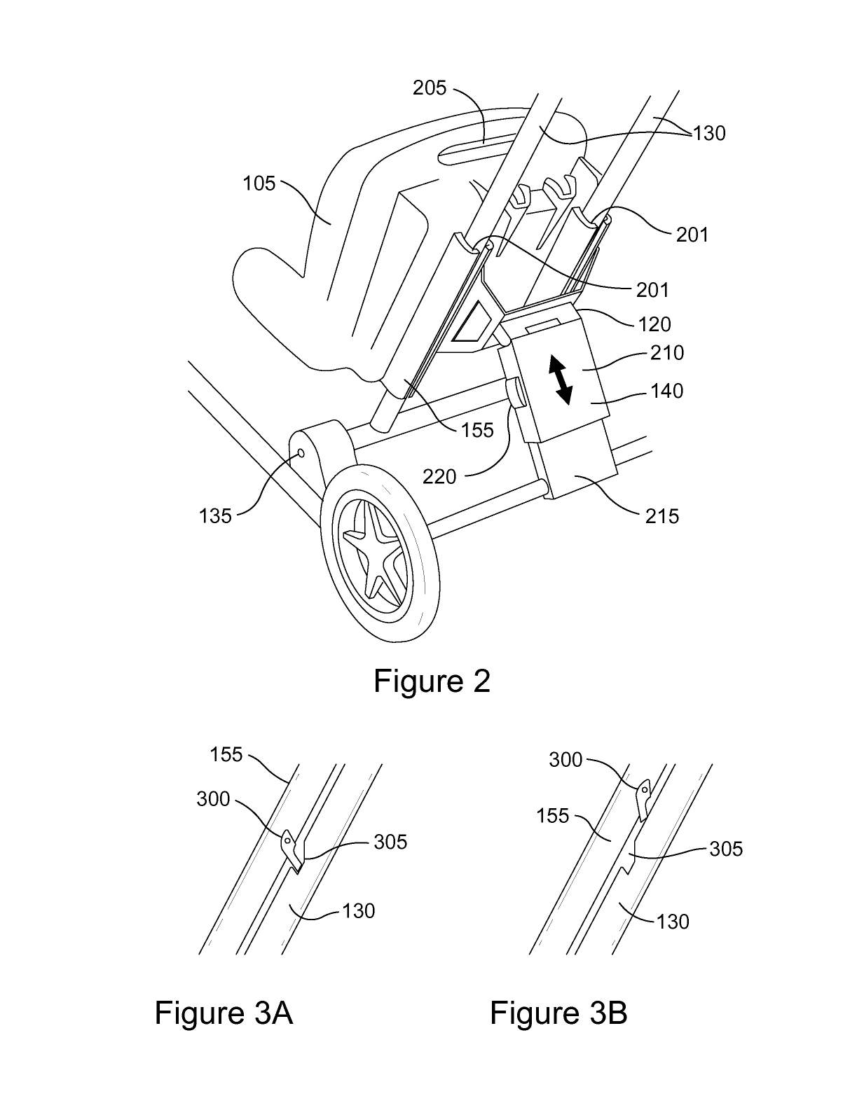

FIG. 2 is a side perspective view of exemplary adjustment means for a convertible stroller, in accordance with an embodiment of the present invention. In the present embodiment, a seating area 105 attaches to handles 130 of the frame of the stroller by braces 155 with semi-circular channels 201 that are of matching diameter to handles 130. Channels 201 grasp handles 130 and generally ensure a secure fit while still providing easy motion up and down handles 130. Locking latches within channels 201 secure seating area 105 in a chosen vertical position upon handles 130, as shown by way of example in FIGS. 3A and 3B. A release lever 205 for these locking latches enables seating area 105 to be moved upon handles 130. Release lever 205 is an ergonomic spring-loaded grip handle and is located near the top of seating area 105 for ease of operation as a user can hold down release lever 205 and pull up or push down seating area 105 with one hand. This leaves the other hand free to support stroller 100, help with the adjustment of stroller 100, comfort the child, etc. However, in some alternate embodiments the release lever maybe located in various different places on the stroller including, without limitation, on the braces, on the back of the seating area, on the handles, etc. Furthermore, some alternate embodiments may use various different types of means for releasing the latches such as, but not limited to, buttons, spring-loaded knobs, dials, etc.

In the present embodiment a hinge 120, a pivot mount 135 and sliding angle adjustment mechanism 140 adjust the angle of seating area 105. Sliding angle adjustment mechanism 140 comprises an upper member 210 and a lower member 215 that slides within upper member 210 and spring-loaded tabs that secure adjustment mechanism 140 in the desired position. Angle adjustment mechanism 140 also comprises two spring-loaded buttons 220 for controlling the spring-loaded tabs that can be operated by one hand. By being able to engage both buttons 220 with one hand, the other hand is left available to help support stroller 100, to help instigate the movement needed to reach the desired angle setting, to comfort the child, etc. Those skilled in the art, in light of the teachings of the present invention, will readily recognize that a multiplicity of suitable means may be used to adjust the angle of the seating area in some alternate embodiments including, without limitation, sliding members held in place with set pins, a hinged mechanism with a lower end that moves horizontally, a ratcheting mechanism, etc.

FIGS. 3A and 3B illustrate an exemplary locking latch 300, in accordance with an embodiment of the present invention. FIG. 3A is a cross sectional view of latch 300 in a locked position, and FIG. 3B is a cross sectional view of latch 300 in a retracted position. In the present embodiment, locking latch 300 is a pivoting latch projecting from the interior sidewall of a semicircular channel in a brace 155 of a seating area of a convertible stroller. Latch 300 fits within and locks upon an aligned recess 305 within a handle 130 of the frame of the stroller. Multiple recesses are strategically placed along handle 130 to enable the seating area to be adjusted to multiple positions on handle 130. The operation of pivoting latch 300 is controlled by a release lever that is featured upon the top horizontal plane of the seating area, as shown by way of example in FIG. 2. In the present embodiment, locking latches are included, without limitation, on both sides of the seating area; however, some alternate embodiments may comprise a locking latch on one side only.

Referring to FIG. 3B, in the present embodiment when the spring-loaded release lever is engaged, latch 300 retracts to enable the seating area to slide freely on handle 130, and referring to FIG. 3A, when this release lever is released, latch 300 pivots out away from brace 155 and automatically locks into place within the next recess 305 securing the seating area. The handle design of the release lever on the seating area typically enables a user to maintain firm control of the seating area so that they are able to slowly raise and lower the seating area as desired. However, if the hand of the user slips from the release lever, the seating area only slides down to the next set of recesses 305; the seating area typically does not slide down the entire length of handles 130. This generally ensures that the occupying child does not crash down to the bottom of handles 130 if the user's hand slips. It is contemplated that a multiplicity of suitable locking mechanisms may be used in some alternate embodiments to hold the seating area in place such as, but not limited to, adjustable pins, ratcheting mechanisms, clamps, etc.

In typical use of the present embodiment, stroller 100 operates as both a stroller and a highchair in its single unit. Referring to FIGS. 1A through 1D, a user may secure a child within seating area 105 with stroller 100 in the stroller position and may then transfer the child to the location of choice. Upon arriving at a location for feeding, the user may lock wheels 125 and move sliding angle adjustment mechanism 140 to raise handles 130 to a more vertical position. Referring to FIG. 2, the user may then squeeze release lever 205, which enables seating area 105 to be raised to a highchair position. The user may then release release lever 205 to secure seating area 105 at the desired height. By allowing seating area 105 to be set at various different heights, stroller 100 can accommodate use in various different environments such as, but not limited to, near tables and other settings of various different heights. Seating area 105 can also be adjusted to an accommodating angle when it is raised for use as a highchair. When no longer needed as a highchair, the user may lower seating area 105 with the retraction of release lever 205 and the return of seating area 105 to a lower setting. Sliding angle adjustment mechanism 140 may then be moved to lower handles 130 to a comfortable height for pushing stroller 100. Referring to FIGS. 1A through 1D, after unlocking wheels 125, stroller 100 may then be used again as a stroller.

In the present embodiment, the child can remain seated within stroller 100 as it is being adjusted in format of use and generally maintains the child in safe and secure positions in all formats of use. Stroller 100 also typically maintains the child in a proper seating position for feeding. Stroller 100 is also easily collapsible for storage and transport. Furthermore, stroller 100 is set for childproof operation as it comprises childproof buttons, latches and levers that typically cannot be operated by small children.

The use of a convertible stroller in accordance with the present embodiment allows families with small children to visit facilities and households that do not have available highchairs and generally eliminates the dependence of families with small children on the highchairs provided by such facilities and other households, which have also typically been used by other small children and often have been cleaned by other persons. This generally ensures that families with small children have access to highchairs that meet their standards of sanitary cleanliness and generally eliminates the risk of small children being exposed to germs, bacteria and other undesirable elements that may accumulate upon highchairs in public environments and can prevent cross-contamination that would ordinarily occur when a child is moved from a publicly accessed highchair to his or her own stroller. The use of a convertible stroller according to the present embodiment also reduces the number of childcare items the user must possess as it accomplishes multiple tasks in a single unit.

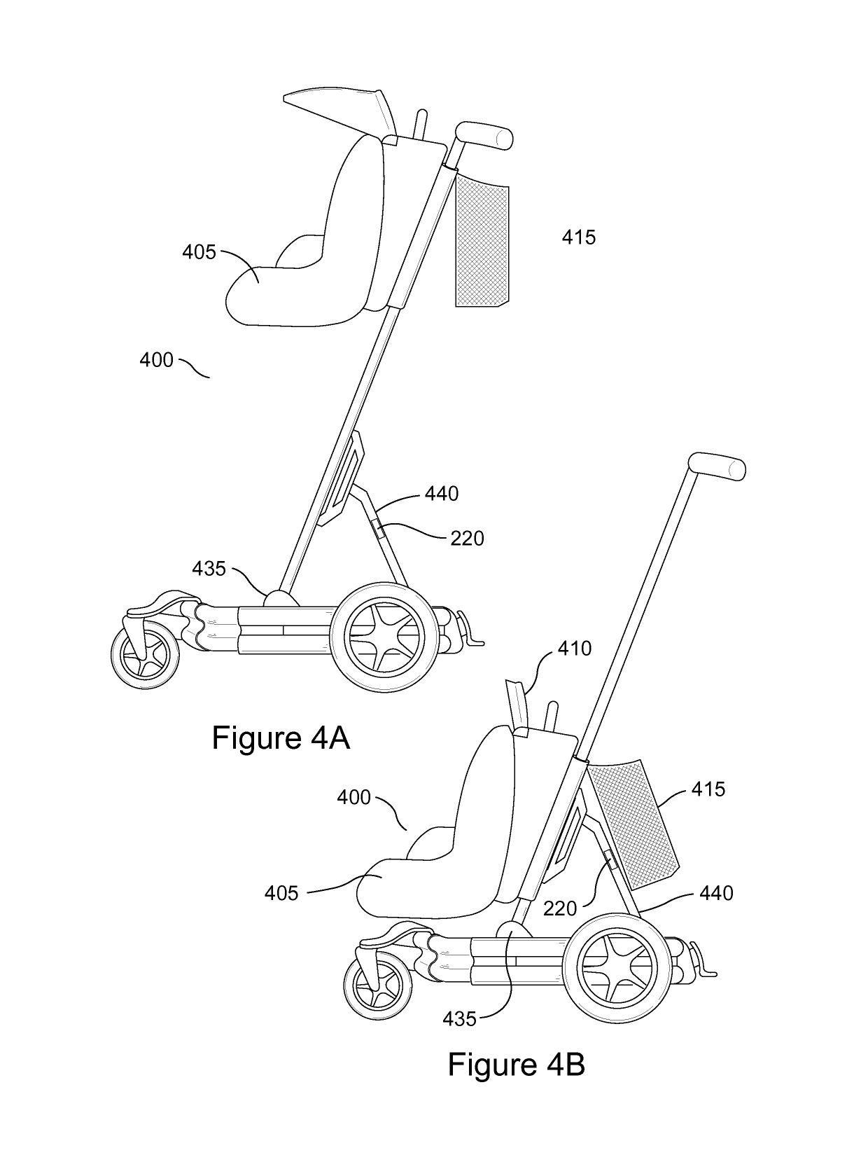

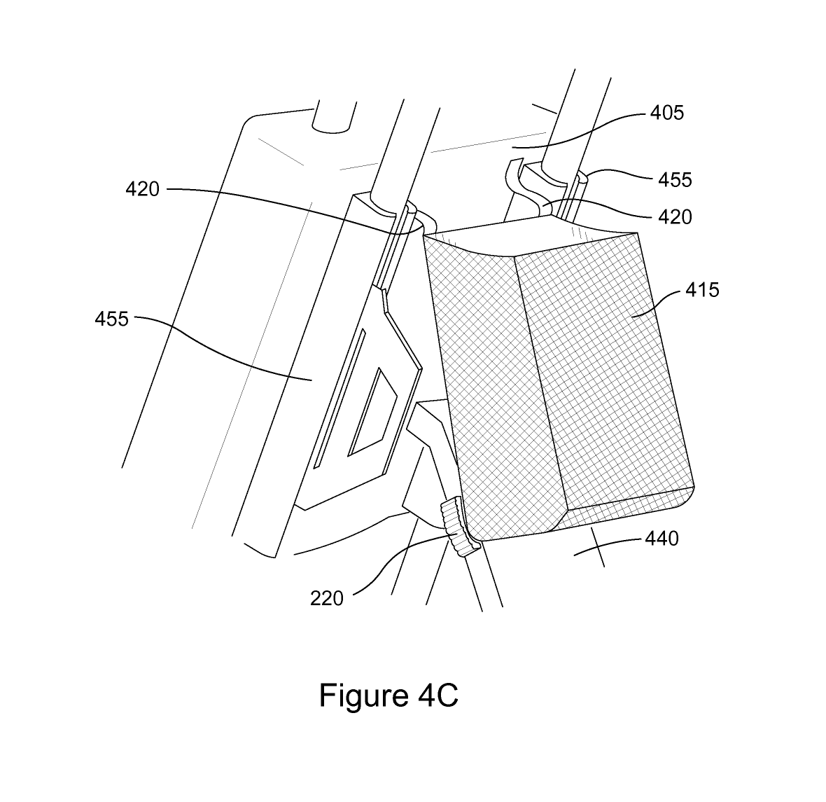

FIGS. 4A through 4C illustrate an exemplary convertible stroller 400, in accordance with an embodiment of the present invention. FIG. 4A is a side view of stroller 400 with a seating area 405 in a highchair position. FIG. 4B is a side view of stroller 400 with seating area 405 in a stroller position, and FIG. 4C is a rear perspective view of seating area 405. In the present embodiment, stroller 400 comprises a canopy 410 and a storage pouch 415. Canopy 410 can be open to provide shade and shelter to seating area 405, as shown by way of example in FIG. 4A, or can be collapsed, as shown by way of example in FIG. 4B. In some alternate embodiments, non-collapsing canopies may be provided. Referring to FIG. 4C, in the present embodiment, storage pouch 415 is attached to seating area 405 by connectors 420 between braces 455. It is contemplated that a multiplicity of suitable attachment means may be used in some alternate embodiments to attach storage pouches to strollers such as, but not limited to, straps, hook and loop material, snaps, clamps, etc. In the present embodiment, the manner of mounting storage pouch 415 enables seating area 405 to be raised and lowered without removing storage pouch 415 from stroller 400 since storage pouch 415 moves along with seating area 405 without interfering with adjustment means including, without limitation, pivot point mounts 435 and a sliding angle adjustment mechanism 440. Storage pouches in some alternate embodiments may be attached to the stroller in various different locations such as, but not limited to, to the handles, to the top of the seating area, to the braces, to the frame, etc. Furthermore, storage in some alternate embodiments may be provided by means other than pouches including, without limitation, plastic bins, wire baskets, pockets, etc.

Those skilled in the art, in light of the teachings of the present invention, will readily recognize that some alternate embodiments may comprise a multiplicity of suitable additional features such as, but not limited to, a removable tray piece to aid its use as a highchair, a hood and/or canopy, pouches and/or pockets for storage of relevant items, insulated pouches for the protection of contents, storage nets, cup holders, lights, music players, etc. Storage pouches and nets in some of these embodiments may be attached to the stroller so as not to interfere with the adjustment mechanisms of the stroller without being removed from the stroller. Furthermore, some embodiments may be made in various different colors and/or patterns, and may or may not bear various images, logos and/or designs, which may or may not be of registered trademark and/or logo status.

Some alternate embodiments of the present invention may be made in various different sizes and shapes and may have various different maximum weight capacities. One alternate embodiment may comprise a seating area that is completely removable. This removable seating area may be used for different purposes such as, but not limited to, as a carrier, booster seat or car seat. Another alternate embodiment can be implemented as a two- (2) seat/double occupancy variation for use with two (2) infants. Yet another alternate embodiment can be implemented as a sit-and-stand variety that accommodates one (1) infant and one (1) toddler. In this embodiment, the stroller accommodates the seated infant when the seat is raised for use as a high chair.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of providing a convertible stroller according to the present invention will be apparent to those skilled in the art. The invention has been described above by way of illustration, and the specific embodiments disclosed are not intended to limit the invention to the particular forms disclosed. For example, the particular implementation of the seating area may vary depending upon the particular type of handles used. The handles described in the foregoing were directed to substantially straight, cylindrical implementations; however, similar techniques are to provide seating areas that may be attached to handles of various different shapes such as, but not limited to, square tubes, semi-circular tubes, curved handles, etc. Implementations of the present invention with different types of handles and seating areas are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An apparatus comprising:
a frame being configured to support an occupant;
a plurality of wheels being rotatably joined to said frame to enable said frame to roll on a surface;
a handle assembly being pivotally joined to said frame;
an angle adjustment mechanism being joined to said frame and said handle assembly, said angle adjustment mechanism being configured to be operable to support said handle assembly at a plurality of angles relative to said frame;
a seat assembly being configured to seat the occupant, said seat assembly being slidably joined to said handle assembly; and
a locking mechanism being configured to be operable to secure said seat assembly to said handle assembly in a first position with said seat assembly resting on said frame and said angle adjustment mechanism supporting said handle assembly at an angle to recline said seat assembly in which the apparatus is configured as a stroller, said locking mechanism being further configured to be operable to secure said seat assembly to said handle assembly in a second position with said seat assembly supported above said frame and said angle adjustment mechanism supporting said handle assembly at an angle to position said seat assembly in an upright position in which the apparatus is configured as a highchair.

2. The apparatus as recited in claim 1, in which said locking mechanism is further configured to be operable to secure said seat assembly to said handle in a plurality of positions above said frame and the apparatus is configured as an adjustable height highchair.

3. The apparatus as recited in claim 1, in which said handle assembly comprises tubular members upon which said seat assembly slides.

4. The apparatus as recited in claim 3, in which said tubular members comprises cylinder shapes.

5. The apparatus as recited in claim 3, in which said locking mechanism comprises at least one latch pivotally joined to said seat assembly and configured to engage a selected one of a plurality of recesses in said tubular member.

6. The apparatus as recited in claim 3, in which said locking mechanism comprises at least one latch, for each tubular member, pivotally joined to said seat assembly and configured to engage a selected one of a plurality of recesses in said tubular member.

7. The apparatus as recited in claim 5, in which said at least one latch is urged to engage a recess.

8. The apparatus as recited in claim 5, in which said seat assembly further comprises a release lever being configured to disengage said at least one latch from said recess.

9. The apparatus as recited in claim 8, in which said release lever is disposed on a top back of said seat assembly.

10. The apparatus as recited in claim 8, in which said release lever comprises a spring-loaded grip.

11. The apparatus as recited in claim 1, in which said angle adjustment mechanism further comprises an upper member and a lower member that slides within said upper member.

12. The apparatus as recited in claim 1, further comprising a safety harness being configured to secure the occupant in said seat assembly.

13. The apparatus as recited in claim 1, further comprising a canopy being joined to said seat assembly.

14. The apparatus as recited in claim 1, further comprising a storage pouch being joined to said seat assembly.

15. An apparatus comprising:
a frame being configured to support an occupant;
means for enabling said frame to traverse a surface;
means for moving said frame along the surface;
means for supporting said moving means at a plurality of angles relative to said frame;
means for seating the occupant, said seating means being slidably joined to said moving means;
means for securing said seating means in a first position with said seating means resting on said frame and said supporting means supporting said moving means at an angle to recline said seating means in which the apparatus is configured as a stroller, said securing means being further operable for securing said seating means in a plurality of positions with said seating means supported above said frame and said supporting means supporting said moving means at angle to position said seating means in an upright position in which the apparatus is configured as an adjustable height highchair; and
means for disengaging said securing means.

16. The apparatus as recited in claim 15, further comprising means for securing the occupant in said seating means.

17. An apparatus comprising:
a frame being configured to support an occupant;
a plurality of wheels being rotatably joined to said frame to enable said frame to roll on a surface;
a handle assembly being pivotally joined to said frame, said handle assembly comprising at least two cylindrical tubular members each comprising a plurality of recesses;
an angle adjustment mechanism being joined to said frame and said handle assembly, said angle adjustment mechanism being configured to be operable to support said handle assembly at a plurality of angles relative to said frame, said angle adjustment mechanism comprising an upper member and a lower member that slides within said upper member;
a seat assembly being configured to seat the occupant, said seat assembly being slidably joined to said tubular members;
a locking mechanism comprising at least one latch, for each tubular member, pivotally joined to said seat assembly and configured and urged to engage a selected one of said plurality of recesses in said tubular member, said locking mechanism being configured to be operable to secure said seat assembly to said handle assembly in a first position with said seat assembly resting on said frame and said angle adjustment mechanism supporting said handle assembly at an angle to recline said seat assembly in which the apparatus is configured as a stroller, said locking mechanism being further configured to be operable to secure said seat assembly to said handle assembly in a plurality of positions with said seat assembly supported above said frame and said angle adjustment mechanism supporting said handle assembly at an angle to position said seat assembly in an upright position in which the apparatus is configured as an adjustable height highchair; and
a release lever being configured to disengage said latch from said recess, said release lever comprising a spring-loaded grip disposed on a top back of said seat assembly.

18. The apparatus as recited in claim 17, further comprising a safety harness for securing the occupant in said seat assembly.

19. The apparatus as recited in claim 17, further comprising a canopy being joined to said seat assembly.

20. The apparatus as recited in claim 17, further comprising a storage pouch being joined to said seat assembly.
